(19) United States
(12) Patent Application Publication
(10) Pub. No.: US 2009/0010470 A1
(43) Pub. Date: Jan. 8, 2009

(54) Resonating Speaker

(76) Inventor: Yan-Min WANG, Taichung City (TW)

Correspondence Address: Dr. BANGER SHIA, 102 Lindencrest Ct., Sugar Land, TX, 77479-5201, US

(21) Appl. No.: 11/782,604

(22) Filed: Jul. 24, 2007

(30) Foreign Application Priority Data
Jul. 3, 2007 (TW) 096210840

(51) Int. Cl. H04R 1/20

(52) U.S. Cl. 381/353

(57) ABSTRACT

A resonating speaker comprises: an upper cover, an upper magnet, a positioning member, a magnetostrictive member, a coil, a lower magnet, a lower cover and a sound-transmitting member. The upper magnet, the positioning member, the magnetostrictive member, and the lower magnet are disposed in the upper cover. And then the connecting portion of the lower cover is connected to that of the upper cover, so that the lower magnet, the magnetostrictive member, and the upper magnet are pressed onto the upper cover by the upper cover, while leaving resonance space between the upper and lower covers. The vibration-transmitting member is fixed to the lower cover. Hence, the resonating speaker is small and easy to carry, and can play sound simply by puffing it on a sound-transmitting medium.

### BACKGROUND OF THE INVENTION

1. Field of the Invention

The present invention relates to a resonating speaker, and more particularly to a resonating speaker which can play sound by putting it on a flat surface as a sound-transmitting medium.

2. Description of the Prior Art

The operation principle of a conventional speaker is to imitate human voice-producing activity-humans produce sound by expelling air through the larynx. However, the speaker is an energy conversion device for converting electric energy into mechanical energy, and then the mechanical energy vibrates the surrounding air to produce sound. That is to say that the speaker is connected to a power source via a power wire, the current flows through the coil of the speaker to produce a magnetic field effect, and then the two permanent magnets at both ends of the coil will repel each other when their positive poles are put together, at this moment, the vibrating membrane of the speaker will shrink inward. And the two permanent magnets will attract each other when the negative pole and the positive pole are put together, at this moment, the vibrating membrane of the speaker will expand outward. The instant wave or airflow caused by the expansion or shrinkage produces sound, and then the sound is amplified by sound box. After further study, we found this conventional structure still has the following problems:

The speaker must use a sound box to amplify the sound, which increases the material cost, and makes the speaker difficult to carry, thus limiting the applicability of the speaker.

In view of this, the inventor of the present invention, based on many years of experiences and research, has invented a resonating speaker.

### SUMMARY OF THE INVENTION

The primary objective of the present invention is to provide a resonating speaker which can play sound by put it on a sound-transmitting medium.

To achieve the above objective, a resonating speaker in accordance with the present invention comprises: an upper cover, an upper magnet, a positioning member, a magnetostrictive member, a coil, a lower magnet, a lower cover and a sound-transmitting member. The upper magnet, the positioning member, the magnetostrictive member, and the lower magnet are disposed in the upper cover. And then the connecting portion of the lower cover is connected to that of the upper cover, so that the lower magnet, the magnetostrictive member, the positioning member and the upper magnet are pressed onto the upper cover by the upper cover, while leaving resonance space between the upper and lower covers. The vibration-transmitting member is fixed to the lower cover. Hence, the resonating speaker is small and easy to carry, and can play sound simply by putting it on a sound-transmitting medium.

### BRIEF DESCRIPTION OF THE DRAWINGS

FIG. 1 is an exploded view of a resonating speaker in accordance with a preferred embodiment of the present invention;

FIG. 2 is a cross sectional view of the resonating speaker in accordance with the preferred embodiment of the present invention; and

FIG. 3 is another cross sectional view of the resonating speaker in accordance with the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

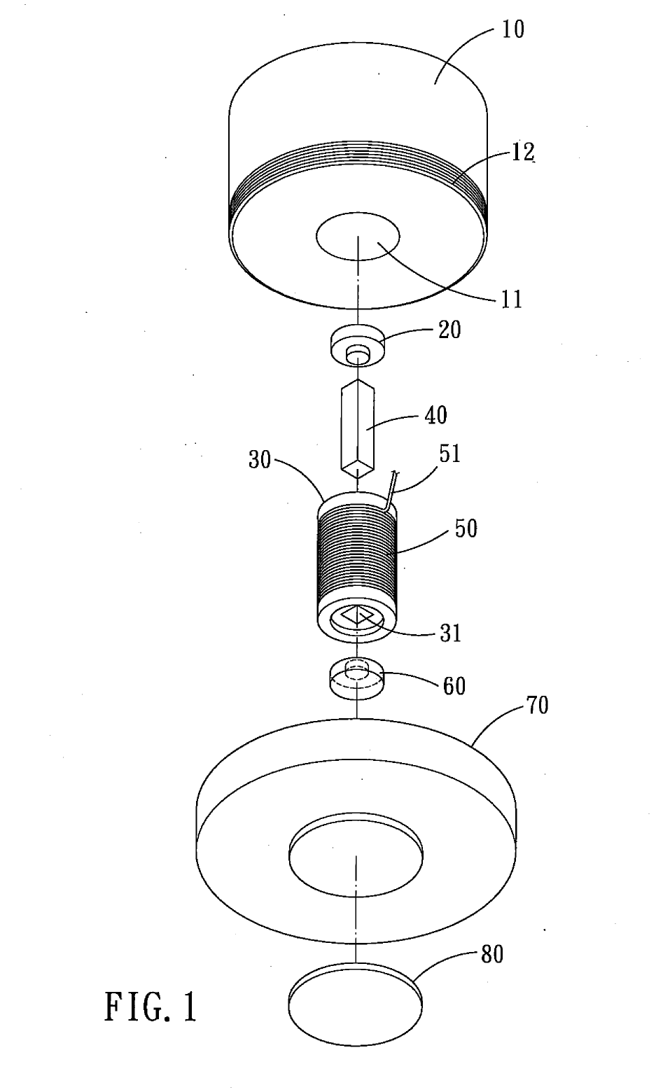

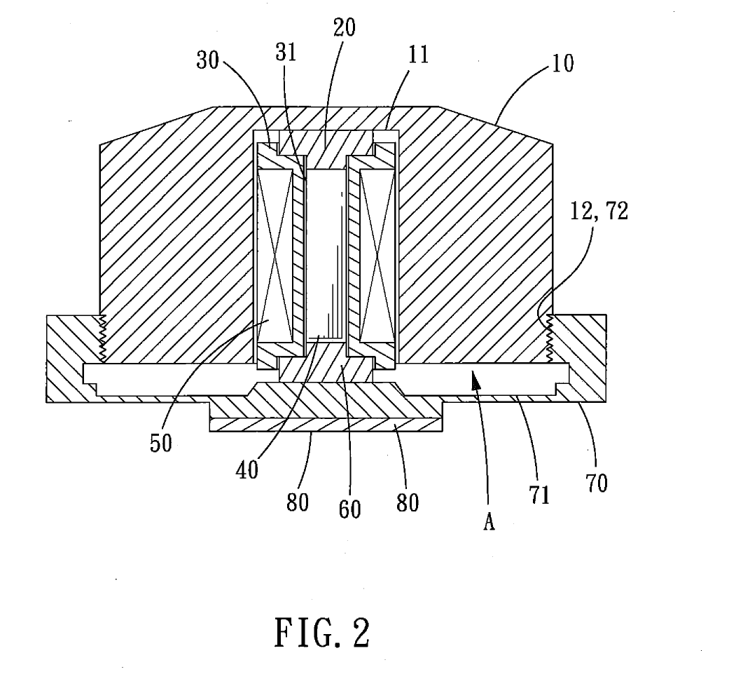

Referring to FIGS. 1 and 2, a resonating speaker in accordance with a preferred embodiment of the present invention is shown and comprise: an upper cover 10, an upper magnet 20, a positioning member 30, a magnetostrictive member 40, a voice coil 50, a lower magnet 60, a lower cover 70, and a vibration-transmitting member 80.

The upper cover 10 is an elastic unitary structure made of metal material. In the center of the upper cover 10 is formed an accommodating portion 11 in the form of a circular cavity. An outer threaded connecting portion 12 is formed on the outer peripheral surface of the upper cover 10 and located correspondingly to the accommodating portion 11.

The upper magnet 20 is received in and pressed against the accommodating portion 11 of the upper cover 10.

The positioning member 30 is a cylinder with an inserting portion 31 that is open toward both ends thereof and is aligned with the accommodating portion 11 of the upper cover 10. The positioning member 30 is disposed in the accommodating portion 11 of the upper cover 10 and presses against the upper magnet 20.

The magnetostrictive member 40 is an alloy unitary structure which is formed in the shape of and is inserted in the inserting portion 31 of the positioning member 30 in such a manner that one end of the magnetostrictive member 40 presses against the upper magnet 20.

The voice coil 50 is enameled wound around the outer surface of the positioning member 30.

The lower magnet 60 contacts the positioning member 30 and is pressed against the other end of the magnetostrictive member 40.

The lower cover 70 is an elastic unitary structure made of metal material and is defined in the center thereof with an accommodating portion 71 in the form of a circular cavity. The diameter of the accommodating portion 71 is larger than that of the accommodating portion 11 of the upper cover 10. An inner threaded connecting portion 72 is formed on the inner surface of the lower cover 70 and is located at the open end of the accommodating portion 71, for meshing with the connecting portion 12 of the upper cover 10, in such a manner that the accommodating portion 71 of the lower cover 70 presses against the lower magnet 60, so that the lower magnet 60, the magnetostrictive member 40, and the upper magnet 20 are pressed onto the upper cover 10 by the upper cover 10, while leaving resonance space A between the upper and lower covers 10, 70.

The vibration-transmitting member 80 is a circular sheet-shaped unitary structure made of rubber material with a damping effect and is fixed at the center of the lower cover 70.

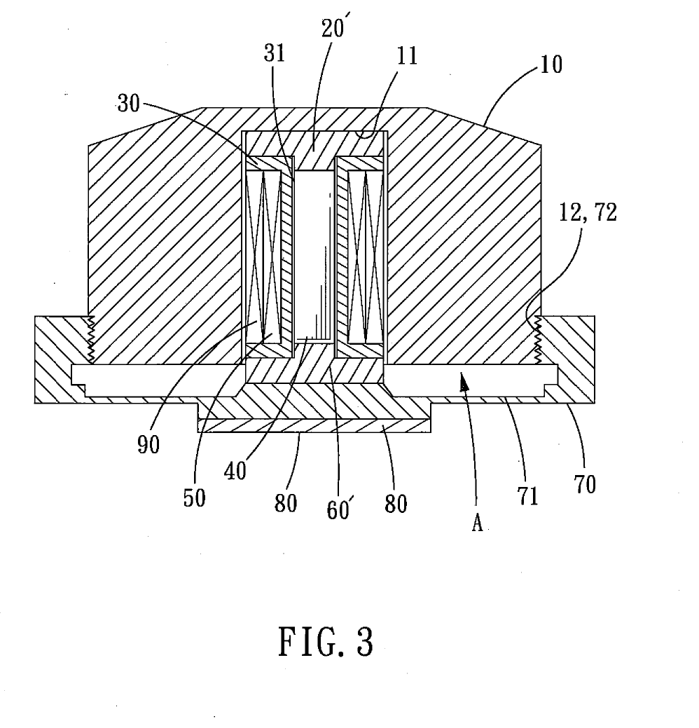

As shown in FIG. 3, another embodiment of the resonating speaker further comprises a magnetic bias coil 90 made of enameled wire wound around the voice coil 50, so that the positioning member 30 is surrounded by the magnetic voice coil 50 and the magnetic bias coil 90 at the same time. And the upper and lower magnets 20, 60 are replaced by an upper magnetic conductive member 20′ and a lower magnetic conductive member 60′.

The relationships and the structures of the relative components of the preferred embodiment are as described above.

And for a better understanding of the present invention, its operation and function, reference should be made to the following detailed description, taken in conjunction with FIGS. 2 and 3.

In assembly, the upper magnet 20, the positioning member 30, the magnetostrictive member 40 and the lower magnet 60 are disposed sequentially in the accommodating portion 11 of the upper cover 10. And then the connecting portion 72 of the lower cover 7 is screwed with the connecting portion 12 of the upper cover 10, so that the lower magnet 60, the magnetostrictive member 40, the positioning member 30 and the upper magnet 20 are closely pressed against and positioned by the upper cover 10.

When in use, the magnetic voice coil 50 and the magnetic bias coil 90 guide voice current and bias current to the resonating speaker, and then the voice current and bias current flow through the magnetic voice coil 50 or the magnetic bias coil 90 to produce a voice magnetic field and a magnetic bias field, and then flow through the upper magnet 20, the magnetostrictive member 40 and the lower magnet 60 to produce a magnetic field effect. Changing the current flowing through the magnetic voice coil 50 or the magnetic bias coil 90 can change the magnetic field density, and with the cooperation of the resonating space A between the upper cover 10 and the lower cover 7, the sound is transmitted to the vibration-transmitting member 80. The user can put the vibration-transmitting member 80 onto a sound-transmitting medium to produce resonance, and then sound can be produced and transmitted. The resonating speaker is small and easy to carry, and can play sound simply by putting it on a sound-transmitting medium.

To summarize, a resonating speaker in accordance with the present invention comprises: an upper cover, an upper magnet, a positioning member, a magnetostrictive member, a coil, a lower magnet, a lower cover and a sound-transmitting member. The upper magnet, the positioning member, the magnetostrictive member, and the lower magnet are disposed in the upper cover. And then the connecting portion of the lower cover is connected to that of the upper cover, so that the lower magnet, the magnetostrictive member, the positioning member and the upper magnet are pressed onto the upper cover by the upper cover, while leaving resonance space between the upper and lower covers. The vibration-transmitting member is fixed to the lower cover. Hence, the resonating speaker is small and easy to carry, and can play sound simply by putting it on a sound-transmitting medium.

While we have shown and described various embodiments in accordance with the present invention, it is clear to those skilled in the art that further embodiments may be made without departing from the scope of the present invention.

What is claimed is:

1. A resonating speaker comprising:
an upper cover defined with an accommodating portion and a connecting portion located correspondingly to the accommodating portion;
an upper magnet disposed in the accommodating portion of the upper cover and pressed against the upper cover;
a positioning member with an inserting portion to be aligned with the accommodating portion of the upper cover being disposed in the accommodating portion of the upper cover and in contact with the upper magnet;
a magnetostrictive member inserted in the inserting portion of the positioning member and pressed against the upper magnet;
a voice coil disposed on the positioning member;
a lower magnet disposed in the accommodating portion of the upper cover and pressed against the magnetostrictive member;
a lower cover defined with an accommodating portion and a connecting portion located correspondingly to the accommodating portion, the connecting portion of the lower cover being jointed to that of the upper cover in such a manner that the accommodating portion of the lower cover is pressed against the lower magnet, while leaving a resonating space between the lower cover and the upper cover; and
a vibration-transmitting member fixed to the lower cover.

2. The resonating speaker as claimed in claim 1, wherein the accommodating portion of the upper cover is a circular cavity, the connecting portion of the upper cover is in the form of outer threads, the accommodating portion of the lower cover is a circular cavity, and the connecting portion of the lower cover is in the form of inner threads for meshing with the connecting portion of the upper cover, the accommodating portion of the lower cover has a larger diameter than the accommodating portion of the upper cover.

3. The resonating speaker as claimed in claim 2, wherein the upper cover is an elastic unitary structure made of metal, the magnetostrictive member is a unitary structure made of alloy, the magnetic voice coil is made of enameled wire, the lower cover is an elastic unitary structure made of metal, and the vibration-transmitting member is a unitary structure made of rubber material with a damping effect.

4. A resonating speaker comprising:
an upper cover defined with an accommodating portion and a connecting portion located correspondingly to the accommodating portion;
an upper magnetic conductive disposed in the accommodating portion of the upper cover and pressed against the upper cover;
a positioning member with an inserting portion to be aligned with the accommodating portion of the upper cover being disposed in the accommodating portion of the upper cover and in contact with the upper magnet;
a magnetostrictive member inserted in the inserting portion of the positioning member and pressed against the upper magnet;
a voice coil disposed on the positioning member;
a lower magnetic conductive disposed in the accommodating portion of the upper cover and pressed against the magnetostrictive member;
a lower cover defined with an accommodating portion and a connecting portion located correspondingly to the accommodating portion, the connecting portion of the lower cover being jointed to that of the upper cover in such a manner that the accommodating portion of the lower cover is pressed against the lower magnet, while leaving a resonating space between the lower cover and the upper cover; and
a vibration-transmitting member fixed to the lower cover.

5. The resonating speaker as claimed in claim 4, wherein the accommodating portion of the upper cover is a circular cavity, the connecting portion of the upper cover is in the form of outer threads, the accommodating portion of the lower cover is a circular cavity, and the connecting portion of the lower cover is in the form of inner threads for meshing with the connecting portion of the upper cover, the accommodating portion of the lower cover has a larger diameter than the accommodating portion of the upper cover.

6. The resonating speaker as claimed in claim 4, wherein the upper cover is an elastic unitary structure made of metal, the magnetostrictive member is a unitary structure made of alloy, the magnetic voice coil is made of enameled wire, the lower cover is an elastic unitary structure made of metal, and the vibration-transmitting member is a unitary structure made of rubber material with a damping effect.

7. The resonating speaker as claimed in claim 1 further comprising a magnetic bias coil made of enameled wire wound around the voice coil, so that the positioning member is surrounded by the magnetic bias coil and the voice coil at the same time.
